(19) United States
(12) Patent Application Publication
(10) Pub. No.: US 2001/0056369 A1
(43) Pub. Date: Dec. 27, 2001

(54) Advertisement posting system, advertisement-cost calculating method, and record medium storing advertisement-cost calculating program

(76) Inventors: Kuniharu Takayama, Chiba (JP); Minoru Sekiguchi, Zama (JP); Yoshiharu Maeda, Chiba (JP); Hirohisa Naito, Urayasu (JP)

Correspondence Address: STAAS & HALSEY LLP, 700 11TH STREET, NW, SUITE 500, WASHINGTON, DC, 20001, US

(21) Appl. No.: 09/769,369

(22) Filed: Jan. 26, 2001

(30) Foreign Application Priority Data
Jun. 16, 2000 (JP) 2000-180818

(51) Int. Cl. G06F 17/60

(52) U.S. Cl. 705/14

(57) ABSTRACT

In a system for posting an advertisement via a network, the cost of the advertisement is set in consideration of a region and location or a time slot and season in which the advertisement is posted; i.e., effectiveness of the advertisement. An advertisement-cost calculation unit calculates the cost of the advertisement in consideration of a geographical factor and/or a temporal factor. An advertisement posting unit posts the advertisement on a display apparatus of an information terminal in a manner related to the geographical factor and/or the temporal factor. The advertisement-cost calculation unit may calculate the cost of the advertisement in consideration of the status of use of the advertisement obtained by a state-of-use acquiring unit and/or user information of the advertisement obtained by a user-information designating/acquiring unit. If necessary, a map display unit displays a map on the display apparatus together with the advertisement.

### BACKGROUND OF THE INVENTION

1. Field of the Invention

The present invention relates to an advertisement posting system which posts an advertisement on an information terminal in a manner related to geographical and temporal factors, and in particular to a technique for calculating advertisement cost in such an advertisement posting system.

Examples of such an information terminal include personal computers used at home or in offices; car navigation systems used in cars; portable terminals and cellular phones used at locations away from home or office, or used while moving on foot or by bus or train; information terminals installed at tourist information centers and other various facilities; and large-sized displays installed at street corners and event sites.

2. Description of the Related Art

Recently, information regarding locations has been utilized in an increasing number of situations; e.g., viewing a map on a personal computer at home or in an office; viewing a route from a present location to a destination by use of a car navigation system in a car; or viewing information regarding surrounding areas by use of a portable terminal or a cellular phone while moving on foot or by bus or train.

Under these circumstances, use of advertisements related to location has started to become of great interest, like advertisement posting including: advertisement posting such that when a user accesses information regarding a certain location by use of a personal computer, an advertisement of a shop at that location is displayed on the personal computer; and advertisement posting such that when a user arrives at a certain location by use of a car navigation system, an advertisement for a facility located near that location is displayed on the car navigation system.

As described above, an advertisement posting system capable of posting an advertisement on an information terminal in a manner related to geographical factors such as region and location is already in use. However, an advertisement posting system capable of calculating the cost of an advertisement in accordance with a region or location at which the advertisement is posted does not exist.

Further, an advertisement posting system capable of posting an advertisement on an information terminal in a manner related to temporal factors such as time slot, season, and type of day such as day of the week or ordinary day/national holiday is already in use. However, an advertisement posting system capable of calculating the cost of an advertisement in accordance with time slot or season during which the advertisement is posted is not used.

Conventionally, there has been used a scheme of posting an advertisement on an information terminal in a manner related to a geographical factor such as region or location or a temporal factor such as time slot or season. However, in general, the cost for such an advertisement has been determined uniformly in accordance with the number of postings of the advertisement regardless of geographical factors or temporal factors.

The scheme of posting an advertisement on an information terminal in a manner related to a geographical factor or a temporal factor is expected to be used more and more. Conceivably, for both an advertiser who requests posting of an advertisement and a provider who provides an advertisement posting system, it is desired to change advertisement cost in accordance with effect of advertisement; i.e. the cost of an advertisement is set high when the effect of the advertisement is large, and is set low when the effect of the advertisement is small. Therefore, there is needed a system for setting advertisement cost in consideration of location and region or time slot and season; e.g., a system which renders advertisement cost higher in a certain location and region or a certain time slot and season which is popular among users or occupies the interest of users, or in which a larger number of requests for advertisement postings are made by advertisers.

### SUMMARY OF THE INVENTION

An object of the present invention is to provide an advertisement posting system which can change advertisement cost in accordance with effect of advertisement; i.e. set the cost of an advertisement high when the effect of the advertisement is large, and set the cost low when the effect of the advertisement is small.

Another object of the present invention is to provide an advertisement posting system which can set advertisement cost in consideration of region and location or time slot and season; e.g., rendering advertisement cost higher in a certain location and region or a certain time slot and season which is popular among users or occupies the interest of users, or in which a larger number of requests for advertisement postings are made by advertisers.

The present invention provides an advertisement posting system comprising: an advertisement-cost calculation unit calculating the cost of an advertisement in consideration of a geographical factor; and an advertisement posting unit posting the advertisement on an information terminal in a manner related to the geographical factor.

The present invention further provides an advertisement posting system comprising: an advertisement-cost calculation unit calculating the cost of an advertisement in consideration of a temporal factor; and an advertisement posting unit posting the advertisement on an information terminal in a manner related to the temporal factor.

These units enables a provider to set and collect the cost of the advertisement in consideration of a region and location or a time slot and season in which the advertisement is posted, thereby enabling setting of substantially fair cost in accordance with advertisement effect.

The present invention further provides a computer-readable record medium, such as a transportable memory, a semiconductor memory, or a hard-disk drive, which stores a program for realizing the above-described processing units by use of a computer.

### BRIEF DESCRIPTION OF THE DRAWINGS

FIG. 1 is a block diagram used for general description of the present invention;

FIG. 2 is a diagram showing contents of an advertisement and exemplary outputs of the advertisement;

FIG. 3 is a diagram showing an exemplary configuration of an advertisement-cost calculation unit;

FIG. 4 shows an example of a base cost calculation table;

FIG. 5 shows an example of a customer/advertisement database;

FIG. 6 is a flowchart showing processing performed by the advertisement-cost calculation unit;

FIG. 7 is a diagram showing an example of an estimate-request accepting screen;

FIG. 8 is a diagram showing an example of an estimate presenting/agreement accepting screen;

FIG. 9 is a diagram showing an example of an advertisement presenting/agreement confirming screen;

FIG. 10 is a flowchart processing an advertisement presenting/map presenting;

FIG. 11 is a flowchart processing for changing advertisement cost;

FIG. 12 is a block diagram showing a first embodiment;

FIG. 13 is a block diagram showing a second embodiment;

FIG. 14 is a block diagram showing a third embodiment;

FIG. 15 is a block diagram showing a fourth embodiment;

FIG. 16 is a block diagram showing a fifth embodiment; and

FIG. 17 is a block diagram showing a sixth embodiment.

### DESCRIPTION OF THE PREFERRED EMBODIMENTS

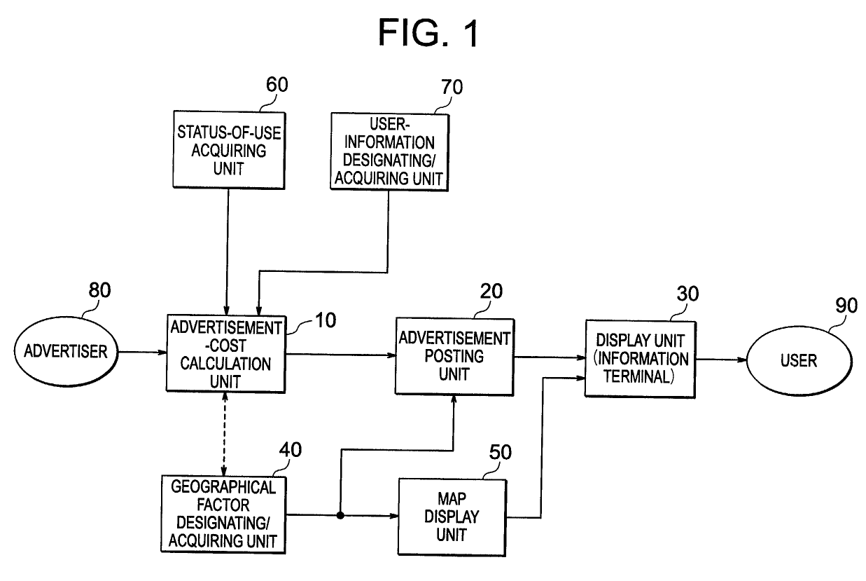

FIG. 1 is a block diagram used for general description of the present invention. An advertisement-cost calculation unit 10 is unit calculating the cost of an advertisement in consideration of a geographical factor or a temporal factor. An advertisement posting unit 20 is unit posting the advertisement on an information terminal in a manner related to the geographical factor or the temporal factor. A display apparatus 30 is a display apparatus of an information terminal such as a personal computer, a cellular phone, or a car navigation system.

A geographical factor designation/acquisition unit 40 is unit obtaining information regarding a geographical factor from location-designation information input by a user or information which represents the latitude and longitude of a position at which the information terminal is present and which is obtained from, for example, a GPS (Global Positioning System). A map display unit 50 is unit which contains map data and displays on the display apparatus 30 a map around a designated location. The map display unit 50 is provided when a map must be displayed on the display apparatus 30. A status-of-use acquisition unit 60 is unit acquiring data regarding the status of use of the advertisement. A user-information designation/acquisition unit 70 is unit designating or acquiring information regarding a user of the advertisement. Reference numeral 80 denotes an advertiser, and reference numeral 90 denotes a user.

The advertisement posting system of the present invention operates as follows. Upon receipt of an advertisement request from the advertiser 80, the advertisement-cost calculation unit 10 calculates the cost of an advertisement in consideration of a geographical factor such as region or location or a temporal factor such as time slot or season. At this time, for the cost calculation, the advertisement-cost calculation unit 10 uses not only the geographical factor or the temporal factor, but also the status of use of the advertisement as obtained by the status-of-use acquisition unit 60 and the user information input or acquired by the user-information designation/acquisition unit 70 if necessary.

The geographical factor designation/acquisition unit 40 acquires information regarding the position of the information terminal on which the advertisement is posted and the location of an object to be advertised and provides the information to the advertisement posting unit 20. When the map display unit 50 is provided, the geographical factor designation/acquisition unit 40 provides the map display unit 50 with information regarding a location to be displayed. The advertisement posting unit 20 provide an advertisement information relating to the designated location to the display apparatus 30 of the information terminal. If necessary, the map display unit 50 displays a map on the display aparatus 30 of the information terminal.

Examples of geographical factors include “location,” “position,” “route,” and “region.”

Examples of temporal factors include “time slot,” “day/night,” “season,” “term,” and “day type” such as day of the week or ordinary day/national holiday.

Examples of advertisements includes those for “shops,” those for “facilities,” and those for “events.”

Examples of information terminal include a “personal computer,” a “car navigation system,” a “portable terminal,” a “cellular phone,” a “street-corner terminal,” and a “large-sized display” attached to a wall of a building or the like.

Examples of states of use include the “number of times of browsing an advertisement” and the “number of times of access.”

Examples of user information include “sex,” “age,” “nationality,” “occupation,” “unmarried/married,” and “parent/childless.”

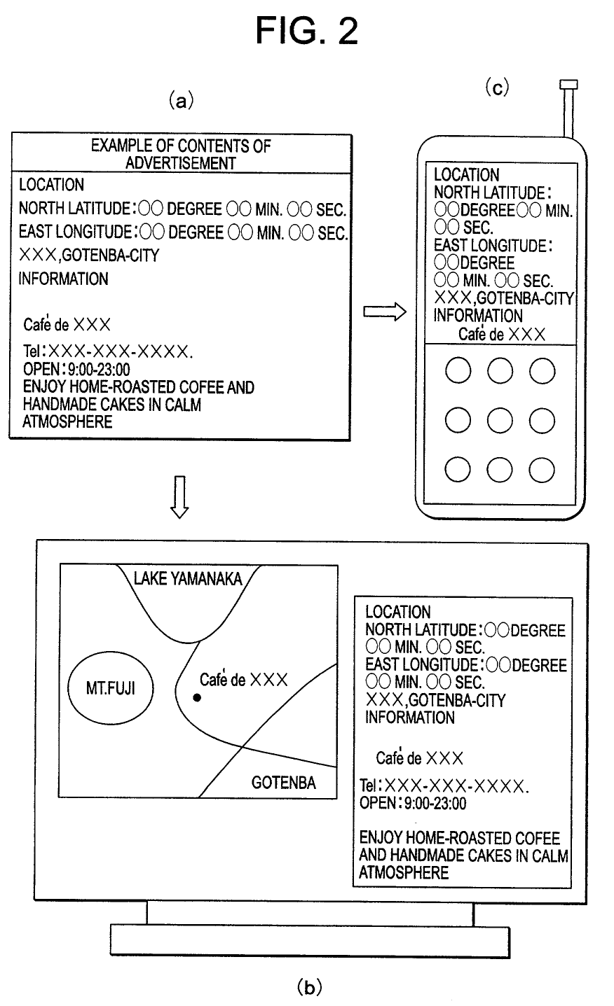

FIG. 2(A) shows an example of information regarding an advertisement requested by the advertiser 80. The advertisement contains not only information representing the contents which are to be actually displayed, but also information representing a geographical factor such as location or temporal information.

FIG. 2(B) shows an exemplary output of the advertisement on an information terminal such as a personal computer. In the case of an information terminal having a display unit 30 having a relatively large screen, such as a personal computer, in addition to the contents of the advertisement requested by the advertiser 80, a map is displayed on the display unit 30 such that a location relating to the advertisement is indicated within the map.

FIG. 2(C) shows an exemplary output of the advertisement on a display panel of, for example, a cellular phone. In the case of an information terminal having a relatively small screen, such as a cellular phone, an advertisement mainly composed of text data is displayed. Needless to say, a simplified map may be displayed together with a simplified map.

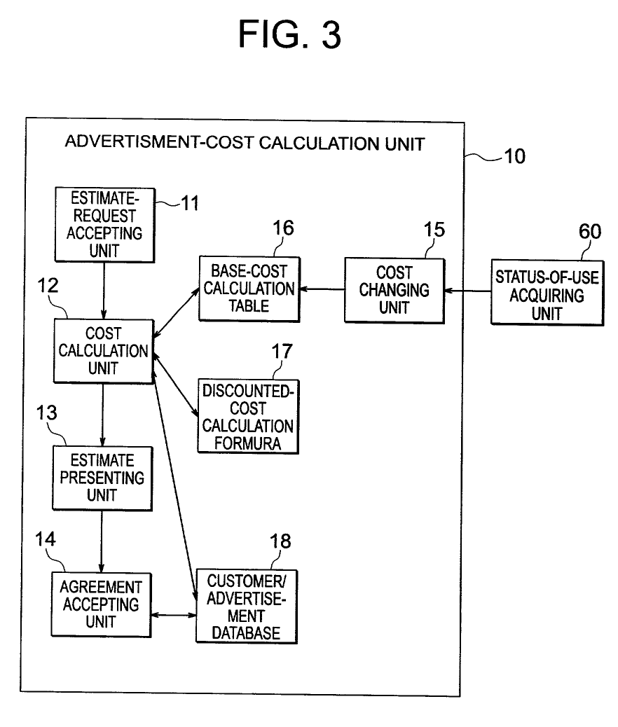

FIG. 3 shows an exemplary configuration of the advertisement-cost calculation unit 10. When a request for posting an advertisement is received from the advertiser 80, the advertisement-cost calculation unit 10 calculates the cost of the advertisement in consideration of a geographical factor or a temporal factor, by use of a table or a database in which an advertisement cost is set for each location or region or each time slot or season, or a calculation formula for calculating an advertisement cost from a location or region or a time slot or season. For such processing, the advertisement-cost calculation unit 10 includes an estimate-request accepting unit 11, a cost calculation unit 12, an estimate presenting unit 13, an agreement accepting unit 14, a cost changing unit 15, a base-cost calculation table 16, a discounted-cost calculation formula 17, and a customer/advertisement database 18.

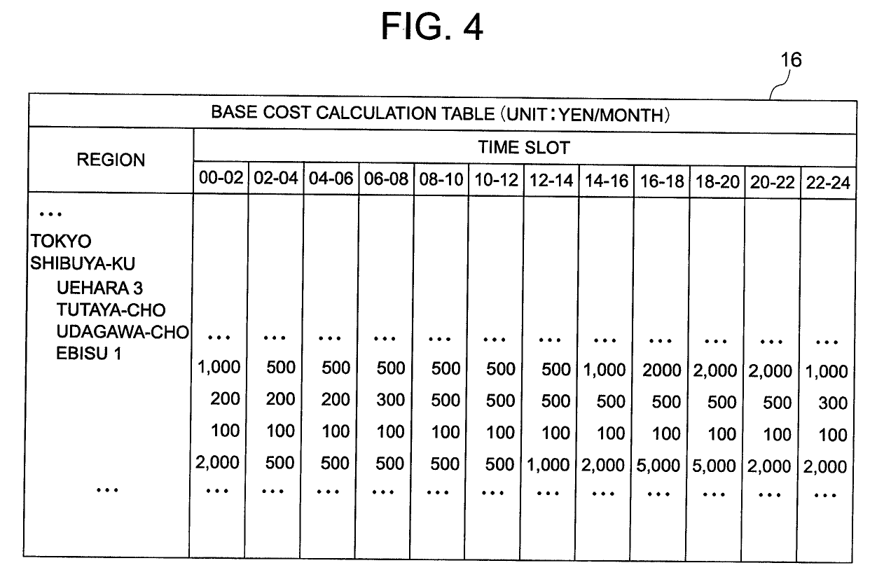

FIG. 4 shows an example of the base-cost calculation table 16. As shown in FIG. 4, in the base-cost calculation table 16, the base cost of an advertisement is set for each combination of a region and a time slot.

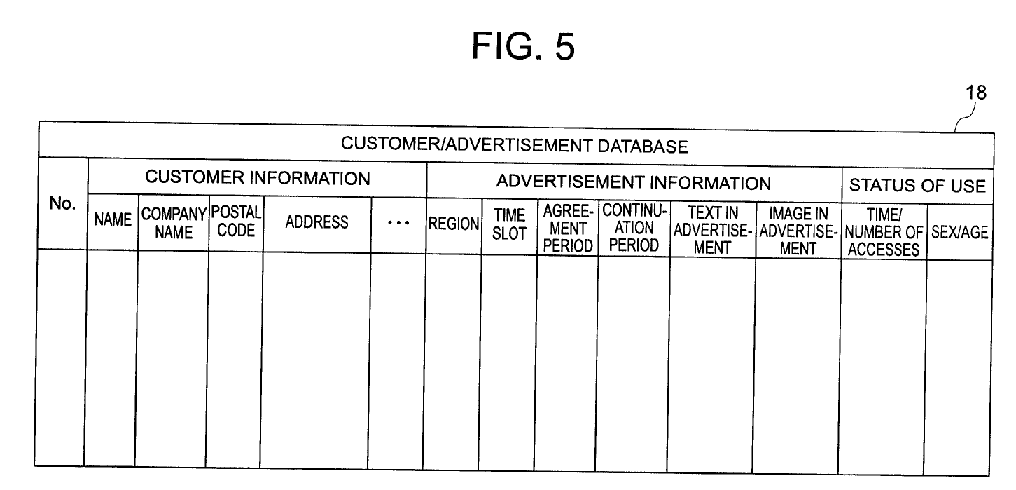

FIG. 5 shows an example of the customer/advertisement database 18. As shown in FIG. 5, in the customer/advertisement database 18 are stored customer data such as name, company name, postal code, address of the advertiser 80; advertisement data such as region, time slot, agreement period, continuing period, the text of the advertisement, and an image used in the advertisement; and data regarding the status of use such as date, time and number of accesses, including user information such as the sex and age of the user 90.

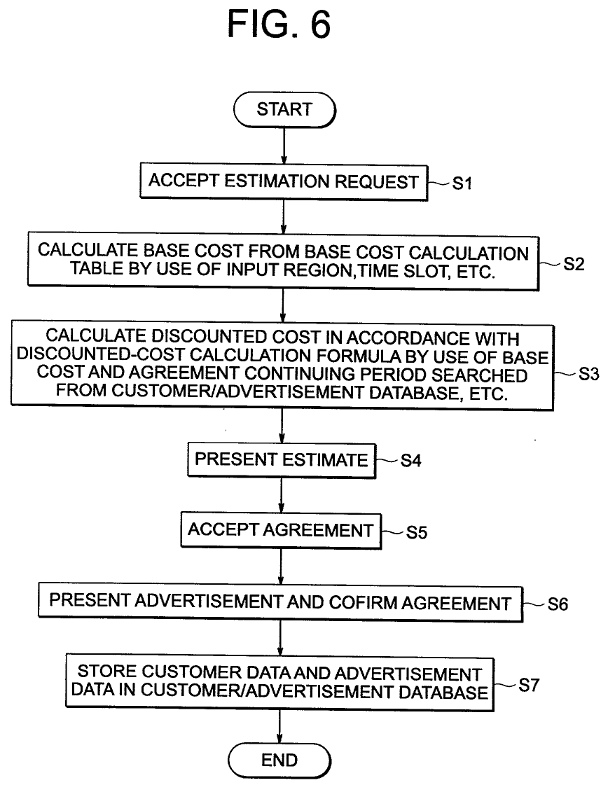

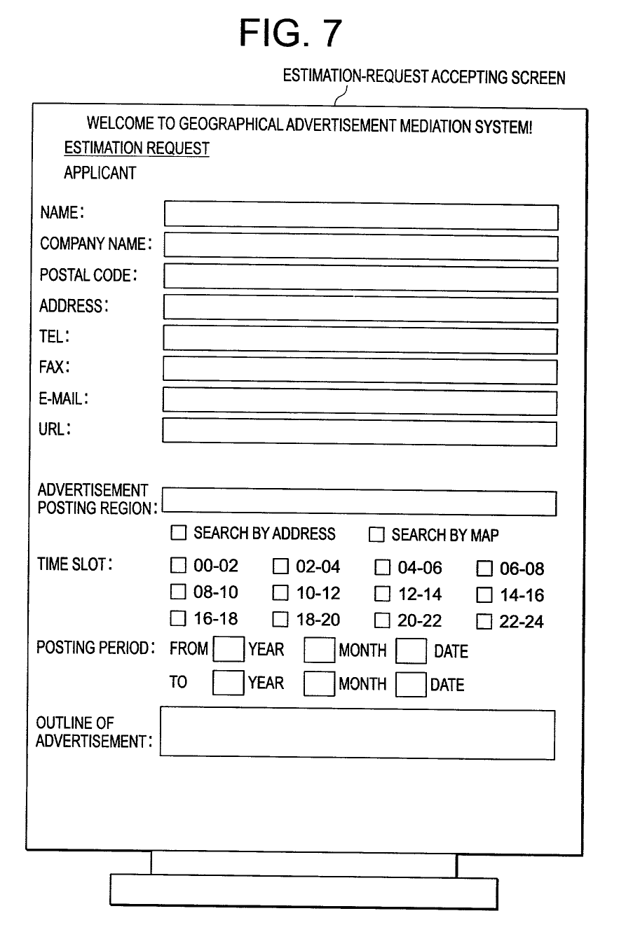

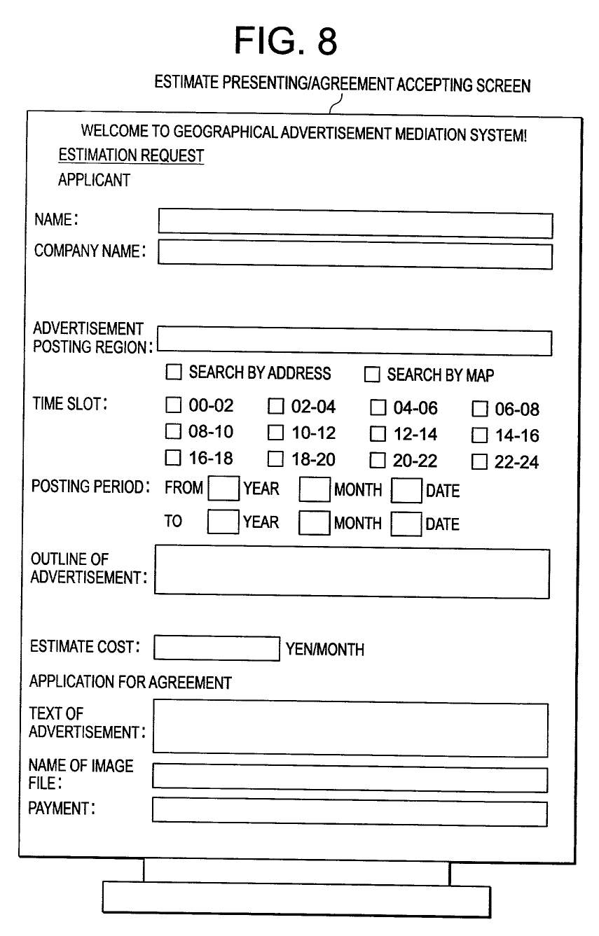

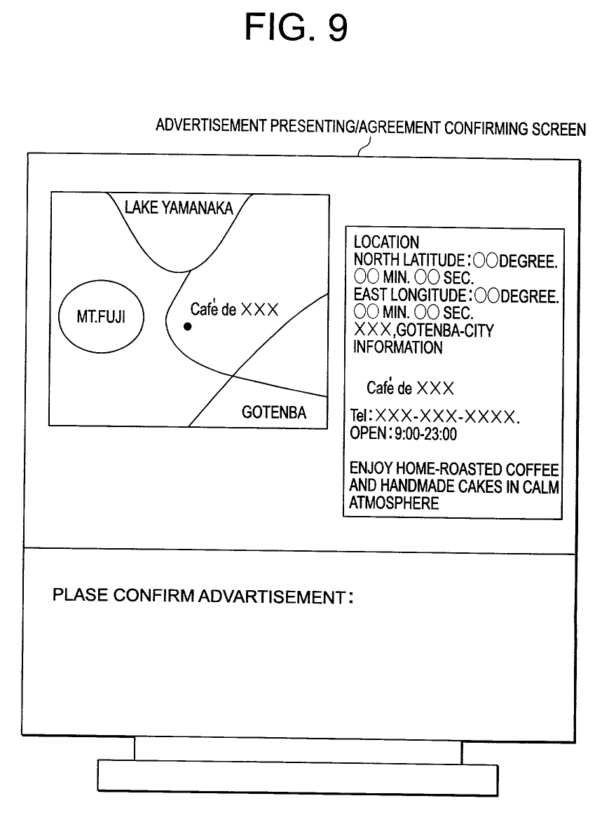

FIG. 6 is a flowchart showing processing performed by the advertisement-cost calculation unit 10; FIG. 7 is a diagram showing an example of an estimate-request accepting screen; FIG. 8 is a diagram showing an example of an estimate presenting/agreement accepting screen; and FIG. 9 is a diagram showing an example of an advertisement presenting/agreement confirming screen.

The estimate-request accepting unit 11 of the advertisement-cost calculation unit 10 shown in FIG. 3 displays on a terminal of the advertiser 80 an estimate-request accepting screen as shown in FIG. 7, and accepts an advertisement estimate request from the advertiser 80 (step S1). Data to be input at the time of accepting the estimate request include name, company name, postal code, address, phone number, facsimile number, e-mail address, and URL (Uniform Resource Locator), which serve as applicant data, when the advertiser 80 has a home page. Further, data regarding an advertisement to be posted include a region in which the advertisement is to be posted, a time slot, a posting period, and an outline of the advertisement.

Subsequently, the cost calculation unit 12 calculates a base cost by use of data, such as region and time slot, input from the estimate-request accepting screen as shown in FIG. 7, and with reference to the base-cost calculation table 16 (step S2).

By use of the thus-calculated base cost and data, such as agreement continuing period, searched from the customer/advertisement database 18, a discounted cost is calculated in accordance with the discounted-cost calculation formula 17 (step S3). An example of the discounted-cost calculation formula 17 is as follows.

Discounted cost=Base cost−Discount calculated on the basis of the total number of time slots−Discount calculated on the basis of an agreement continuing period

After the advertisement cost has been calculated through the above-described processing, the estimate presenting unit 13 displays the estimate presenting/agreement accepting screen as shown in FIG. 8 to thereby present the estimated cost (step S4). By use of the estimate presenting/agreement screen, the agreement accepting unit 14 receives the text of the advertisement, the name of an image file storing the image used in the advertisement, and a payment method, to thereby accept an agreement (step S5).

Upon acceptance of an agreement, the agreement accepting unit 14 displays the advertisement presenting/agreement confirming screen as shown in FIG. 9 and requests the advertiser 80 to confirm the advertisement (step S6). On the advertisement presenting/agreement confirming screen, a map and the contents of the advertisement are displayed in the same manner as that in which the map and the advertisement are to be actually displayed on an information terminal of a user. When the result of the confirmation is OK, customer data such as agreement period, and advertisement data such as region, time slot, and the contents of the advertisement are stored in the customer/advertisement database 18 (step S7). When the result of the confirmation is NG, processing returns to step S1 to thereby request the advertiser 80 to input conditions for a new estimate.

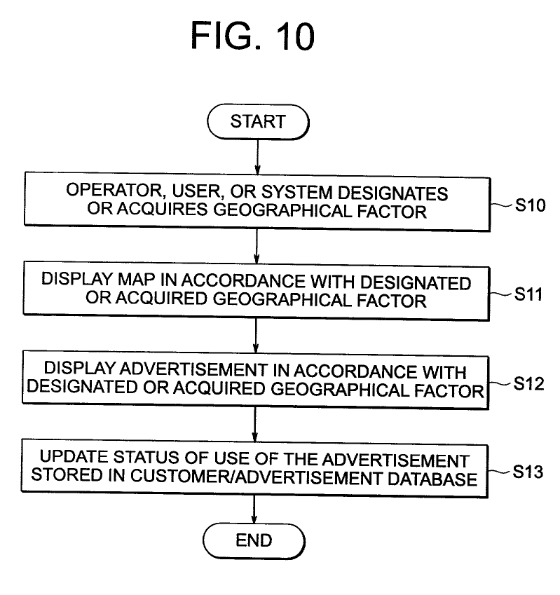

FIG. 10 is a flowchart showing processing for displaying an advertisement and a map, performed in the system shown in FIG. 1. When the geographical factor designation/acquisition unit 40 presents an advertisement to the user 90, the geographical factor designation/acquisition unit 40 acquires a geographical factor designated by an operator of the system or the user 90. Alternatively, the system automatically acquires a geographical factor (step S10). Subsequently, in accordance with the designated or acquired geographical factor, the map display unit 50 displays on the display unit 30 of the information terminal a map relating to the geographical factor (step S11). Simultaneously with the display of the map, the advertisement posting unit 20 displays on the display unit 30 an advertisement relating to the designated or acquired geographical factor (step S12). Subsequently, the status of use of the advertisement stored in the customer/advertisement database 18 is updated (step S13).

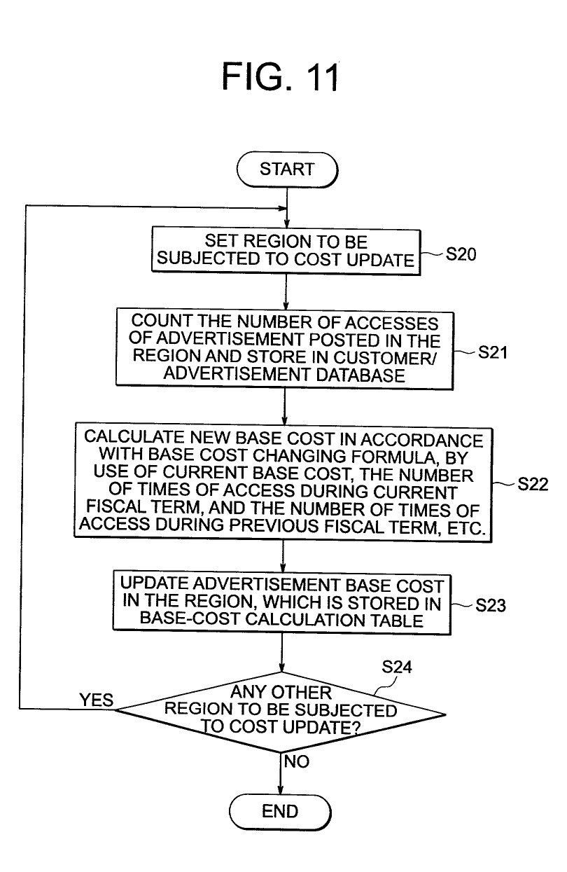

FIG. 11 is a flowchart showing processing for changing advertisement cost, performed by the cost changing unit 15. The cost changing unit 15 periodically executes the processing shown in FIG. 11. First, a region for which advertisement cost must be changed is set (step S20). Subsequently, the number of times of access of an advertisement posted in the region is counted and stored in the customer/advertisement database 18 (step S21). Subsequently, by use of data such as the current base cost, the number of times of access during the current fiscal term, and the number of times of access during the previous fiscal term, a new base cost is calculated in accordance with a predetermined base cost changing formula (step S22). An example of the base cost changing formula is as follows.

New base cost=Current base cost×(the number of times of access during the current fiscal term/the number of times of access during the previous fiscal term)

The status of use in relation to the advertisement in the region, which is stored in the base-cost calculation table 16, is updated (step S23). Subsequently, a judgment is made as to whether advertisement cost must be changed for another region. When the above-described processing has been performed for all the regions for which advertisement cost must be changed, the processing is ended (step S24). When any region for which advertisement cost must be changed remains, the processing returns to step S20 and repeats the above-described processing in a similar manner.

The above-described processing of the advertisement-cost calculation unit 10 enables calculation of an advertisement cost in consideration of a geographical factor such as region or location or a temporal factor such as time slot or season.

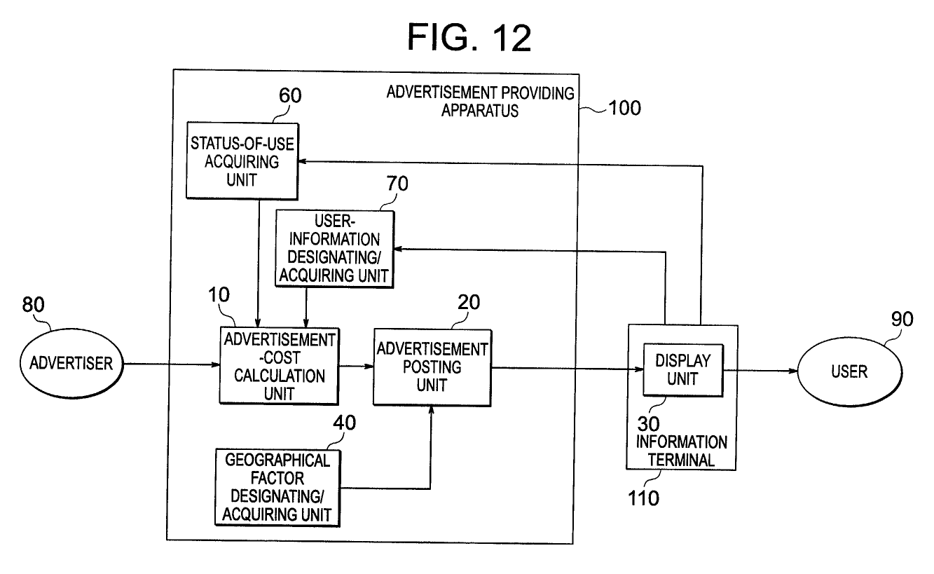

Next, specific embodiments of the present invention will be described with reference to FIGS. 12 to 17.

### First Embodiment

FIG. 12 is a diagram showing a first embodiment, which corresponds to the case in which only an advertisement is transmitted from a center to a cellular phone. That is, an advertisement providing apparatus 100 is an apparatus installed at the center, and an information terminal 110 is a cellular phone or a like device having a display unit 30 having a relatively small screen.

In the advertisement providing apparatus 100, an advertisement-cost calculation unit 10 calculates the cost of an advertisement in consideration of either or both of a geographical factor and a temporal factor. An advertisement posting unit 20 posts the advertisement on the information terminal 110 in a manner related to the geographical factor or the temporal factor.

The basic operation of the advertisement-cost calculation unit 10 at the time of calculating the cost of an advertisement in consideration of a geographical factor is as follows. First, an advertiser 80 presents on the advertisement providing apparatus 100 an advertisement and a geographical factor to which the advertisement is to be related. The advertisement-cost calculation unit 10 of the advertisement providing apparatus 100 calculates the advertisement cost in consideration of the presented geographical factor and presents the thus-calculated advertisement cost to the advertiser 80, thereby receiving an order for posting the advertisement. The advertisement posting unit 20 transmits to the information terminal 110 the advertisement related to the geographical factor. The information terminal 110 displays on the display unit 30 the advertisement related to the geographical factor to thereby enable a user 90 to browse the advertisement. The advertisement-cost calculation unit 10 operates in a similar manner even in cases in which advertisement cost calculation and advertisement posting are performed in consideration of a temporal factor such as time slot, in place of or in combination with the geographical factor.

A geographical factor designation/acquisition unit 40 may be added to the advertisement providing apparatus 100. The geographical factor designation/acquisition unit 40 is unit designating or acquiring a geographical factor depending on the situation, including the case in which the center designates a position and transmits a corresponding advertisement to the cellular phone serving as the information terminal 110; and the case in which the center acquires the position of a PHS (Personal Handyphone System) serving as the information terminal 110 and transmits a corresponding advertisement to the PHS.

The advertisement providing apparatus 100 calculates advertisement cost and receives an order for posting an advertisement. Subsequently, upon acquisition of a geographical factor by the geographical factor designation/acquisition unit 40, the advertisement posting unit 20 checks whether any advertisement is related to the designated or acquired geographical factor. When an advertisement related to the designated or acquired geographical factor is present, the advertisement posting unit 20 presents the advertisement on the information terminal 110.

A status-of-use acquisition unit 60 may be added to the advertisement providing apparatus 100. The status-of-use acquisition unit 60 acquires data regarding the status of use of the advertisement which is related to either or both of a geographical factor and a temporal factor. The advertisement providing apparatus 100 having the status-of-use acquisition unit 60 operates as follows. The advertiser 80 presents on the advertisement providing apparatus 100 an advertisement and a geographical factor (or a temporal factor) to which the advertisement is to be related. The advertisement-cost calculation unit 10 calculates advertisement cost in consideration of the presented geographical factor and presents the thus-calculated advertisement cost to the advertiser 80, thereby receiving an order for posting the advertisement. The advertisement posting unit 20 transmits to the information terminal 110 the advertisement related to the geographical factor. The information terminal 110 displays on the display unit 30 the advertisement related to the geographical factor to thereby enable the user 90 to browse the advertisement. The status-of-use acquisition unit 60 acquires data regarding the status of use of the advertisement related to the geographical factor; i.e., the number of times the advertisement is browsed and the number of times of access. The advertisement-cost calculation unit 10 changes the advertisement cost on the basis of the status of use of the advertisement.

A user-information designation/acquisition unit 70 may be added to the advertisement providing apparatus 100. The user-information designation/acquisition unit 70 designates information regarding a user of the advertisement to be posted. Alternatively, the user-information designation/acquisition unit 70 acquires information regarding a user of the posted advertisement. The advertisement-cost calculation unit 10 changes the advertisement cost on the basis of the user information which has been designated or acquired.

### Second Embodiment

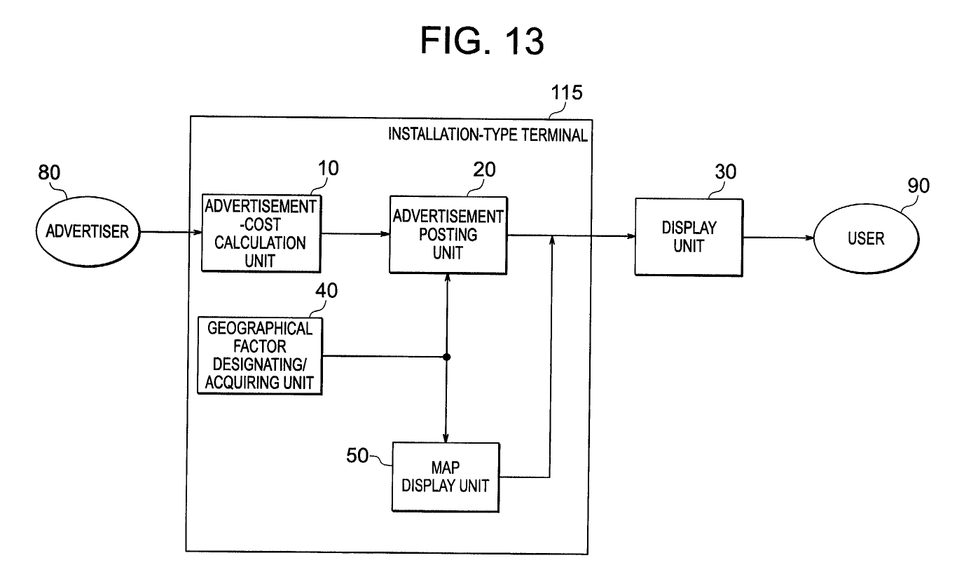

FIG. 13 is a diagram showing a second embodiment. An installation-type terminal 115 is a so-called all-in-one type advertisement providing/posting apparatus which is installed at varous street corner or facilities. The installation-type terminal 115 stores therein map data previously input. The installation-type terminal 115 includes an advertisement-cost calculation unit 10 for calculating the cost of an advertisement in consideration of either or both of a geographical factor and a temporal factor; an advertisement posting unit 20 for posting the advertisement on the display apparatus 30 in a manner related to either or both of the geographical factor and the temporal factor; a geographical factor designation/acquisition unit 40 for designating or acquiring a geographical factor; and a map display unit 50 for displaying on the display apparatus 30 a map which is related to the designated or acquired geographical factor.

The installation-type terminal 115 serving as the advertisement providing/posting apparatus operates as follows. First, an advertiser 80 presents on the installation-type terminal 115 an advertisement and a geographical factor (or a temporal factor) to which the advertisement is to be related. The advertisement-cost calculation unit 10 of the installation-type terminal 115 calculates advertisement cost in consideration of the presented geographical factor and presents the thus-calculated advertisement cost to the advertiser 80, thereby receiving an order for posting the advertisement. The geographical factor designation/acquisition unit 40 reports the designated or acquired geographical factor to the advertisement posting unit 20 and the map display unit 50. The advertisement posting unit 20 displays the advertisement on the display unit 30 in a manner related to the geographical factor. The map display unit 50 displays a corresponding map on the display unit 30 together with the advertisement provided by the advertisement posting unit 20. By use of the display unit 30, a user 90 can browse the advertisement related to the geographical factor.

### Third Embodiment

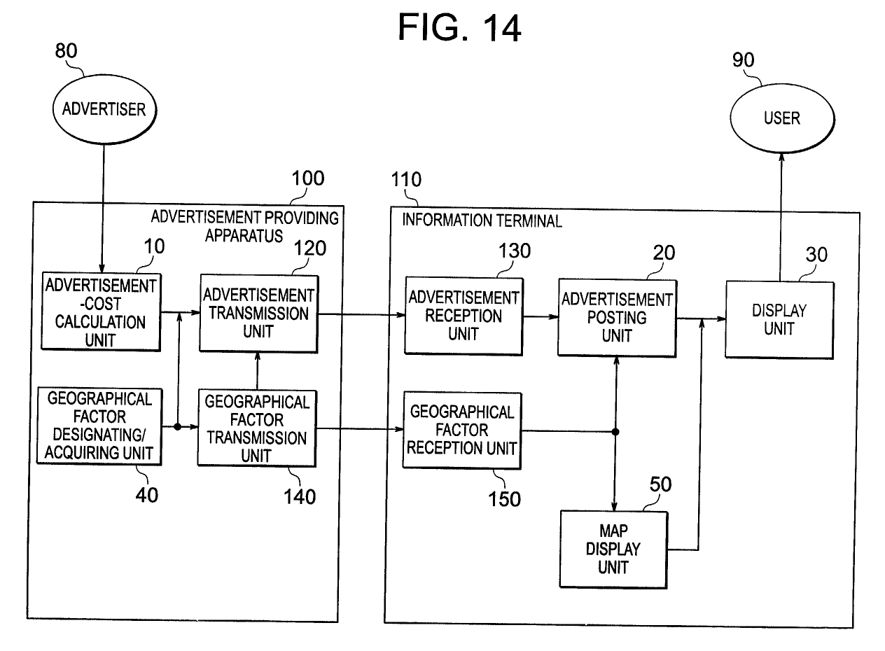

FIG. 14 is a diagram showing a third embodiment characterized by employment of a so-called server/client system which consists of an advertisement providing apparatus 100 serving as a server, and an information terminal 110 serving as a client. A plurality of information terminals 110 may be connected to the single advertisement providing apparatus 100 via a cable network or a radio network. The information terminal 110 is constituted by, for example, a desktop-type personal computer, a portable computer, a PDA (Personal Digital Assistant), or a car navigation system.

The server-side advertisement providing apparatus 100 includes an advertisement-cost calculation unit 10 for calculating the cost of an advertisement in consideration of either or both of a geographical factor and a temporal factor; an advertisement transmission unit 120 for transmitting an advertisement related to a geographical factor (temporal factor) to the information terminal 110 via the network; a geographical factor designation/acquisition unit 40 for designating or acquiring a geographical factor; and a geographical factor transmission unit 140 for transmitting the designated or acquired geographical factor to the information terminal 110 via the network.

The client-side information terminal 110 includes an advertisement reception unit 130 for receiving the advertisement transmitted from the advertisement transmission unit 120; an advertisement posting unit 20 for displaying the received advertisement on the display apparatus 30; a geographical factor reception unit 150 for receiving the geographical factor transmitted from the server side; and a map display unit 50 for displaying on the display apparatus 30 a map which is related to the received geographical factor.

The system shown in FIG. 14 operates as follows. An advertiser 80 presents on the advertisement providing apparatus 100 an advertisement and a geographical factor (or a temporal factor) to which the advertisement is to be related. Through use of the advertisement-cost calculation unit 10, the advertisement providing apparatus 100 calculates advertisement cost in consideration of the presented geographical factor and other factors, and presents the thus-calculated advertisement cost to the advertiser 80, thereby receiving an order for posting the advertisement. Further, the geographical factor designation/acquisition unit 40 reports the designated or acquired geographical factor to the advertisement transmission unit 120 and the geographical factor transmission unit 140. When an advertisement related to the designated or acquired geographical factor is present, the advertisement transmission unit 120 transmits the advertisement to the information terminal 110, and the geographical factor transmission unit 140 transmits the reported geographical factor to the information terminal 110.

In the information terminal 110, the advertisement reception unit 130 receives the advertisement transmitted from the advertisement providing apparatus 100, and the advertisement posting unit 20 outputs the advertisement to the display unit 30. Further, the geographical factor reception unit 150 receives the geographical factor transmitted from the advertisement providing apparatus 100. Together with the advertisement provided by the advertisement posting unit 20, the map display unit 50 displays on the display unit 30 a map which is related to the received geographical factor. By use of the display unit 30, the user 90 can browse the advertisement related to the geographical factor and the like.

### Fourth Embodiment

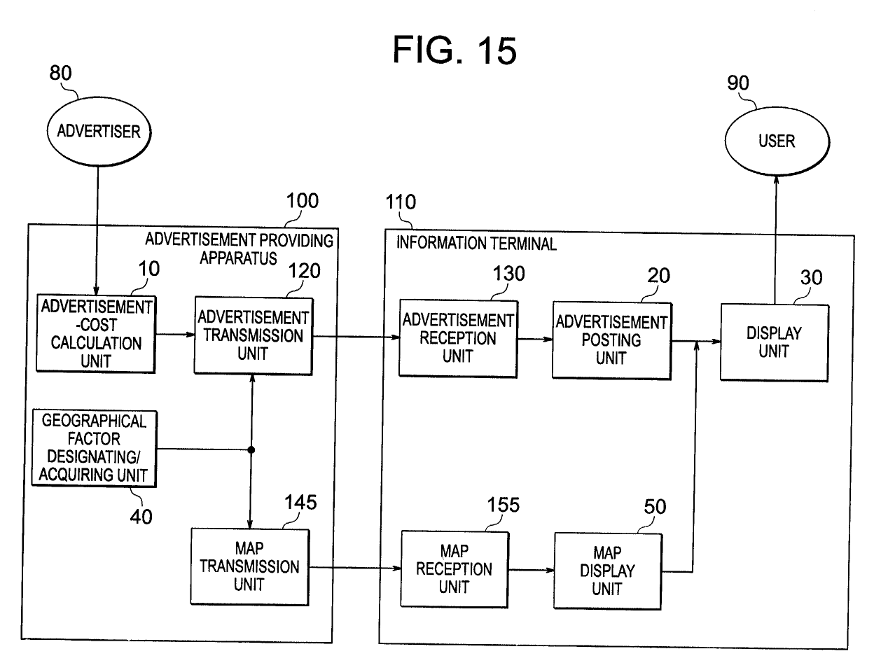

FIG. 15 shows a fourth embodiment. In contrast to the above-described third embodiment in which the information terminal 110 holds map data, in the fourth embodiment, the server-side advertisement providing apparatus 100 holds map data. Therefore, instead of the geographical factor transmission unit 140 used in the third embodiment, the advertisement providing apparatus 100 includes a map transmission unit 145 for transmitting data of a map corresponding to the geographical factor designated or acquired by the geographical factor designation/acquisition unit 40. Further, instead of the geographical factor reception unit 150 used in the third embodiment, the information terminal 110 includes a map reception unit 155. The present embodiment corresponds to the case in which a map and an advertisement are transmitted from a web server to a personal computer.

The geographical factor designation/acquisition unit 40 reports the designated or acquired geographical factor to the advertisement transmission unit 120 and the map transmission unit 145. When an advertisement related to the designated or acquired geographical factor is present, the advertisement transmission unit 120 transmits the advertisement to the information terminal 110. In contrast, the map transmission unit 145 selects a map corresponding to the reported geographical factor, among map data held by the advertisement providing apparatus 100. The thus-selected map is transmitted to the information terminal 110 via the network. In the information terminal 110, the map reception unit 155 receives the map, and the map display means 50 displays the map on the display unit 30. The remaining portions are the same as those in the third embodiment.

### Fifth Embodiment

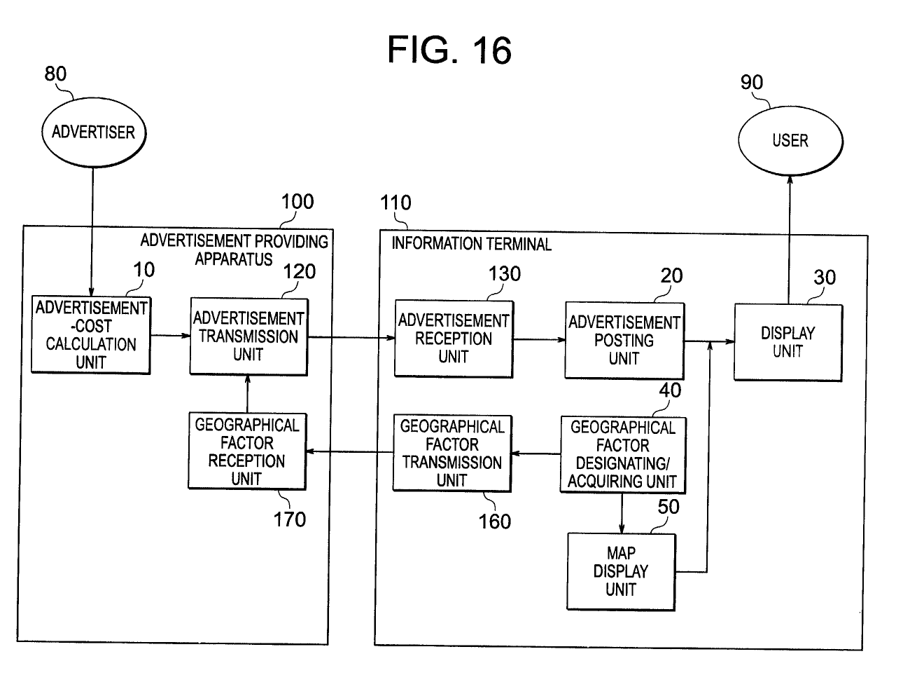

FIG. 16 shows a fifth embodiment. In contrast to the above-described third and fourth embodiments in which the advertisement providing apparatus 100 includes the geographical factor designation/acquisition unit 40, in the fifth embodiment the information terminal 110 includes the geographical factor designation/acquisition unit 40. Further, in the fifth embodiment, the information terminal 110 holds map data which have been input previously. The present embodiment corresponds to the case in which only an advertisement is transmitted from a center to a car navigation system.

The geographical factor designation/acquisition unit 40 reports to the map display means 50 and a geographical factor transmission unit 160 a geographical factor which represents a location designated by a user 90 or a location obtained by use of, for example, a GPS. The map display unit 50 displays on the display apparatus 30 a map related to the reported geographical factor. Further, the geographical factor transmission means 160 transmits the geographical factor to the advertisement providing apparatus 100 via the network.

In the advertisement providing apparatus 100, when a geographical factor reception unit 170 receives the geographical factor transmitted from the information terminal 110, the advertisement transmission unit 120 searches an advertisement which is related to the geographical factor. When an advertisement related to the geographical factor is present, the advertisement transmission unit 120 transmits the advertisement to the information terminal 110.

The advertisement reception unit 130 receives the transmitted advertisement, and the advertisement posting unit 20 displays the advertisement on the display unit 30 together with the map provided by the map display means 50. The operations of the remaining portions, such as the advertisement-cost calculation unit 10, are the same as those in the third and fourth embodiments.

### Sixth Embodiment

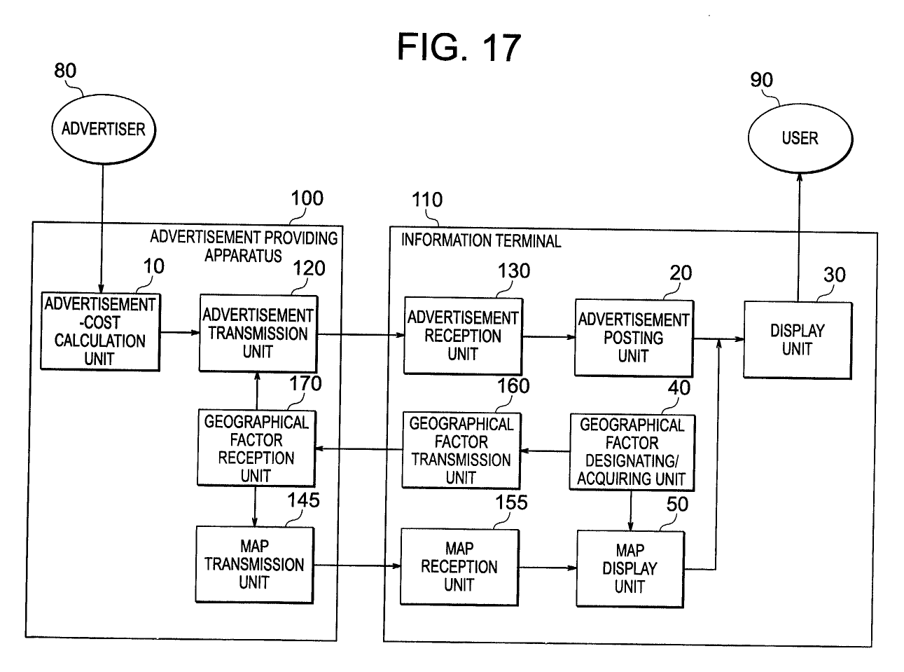

FIG. 17 shows a sixth embodiment. In contrast to the above-described fifth embodiment in which the information terminal 110 holds map data, in the sixth embodiment the advertisement providing apparatus 100 holds map data. Therefore, when the geographical factor designation/acquisition unit 40 of the information terminal 110 acquires a geographical factor, the geographical factor transmission unit 160 transmits the geographical factor to the advertisement providing apparatus 100.

In the advertisement providing apparatus 100, the geographical factor reception unit 170 receives the geographical factor transmitted from the information terminal 110 and reports the geographical factor to the advertisement transmission unit 120 and the map transmission unit 145. The advertisement transmission unit 120 searches an advertisement which is related to the geographical factor. When an advertisement related to the geographical factor is present, the advertisement transmission unit 120 transmits the advertisement to the information terminal 110. The map transmission unit 145 transmits to the information terminal 110 a map corresponding to the geographical factor.

In the information terminal 110, the advertisement reception unit 130 receives the transmitted advertisement, and the advertisement posting unit 20 displays the advertisement on the display unit 30. Further, the map reception unit 155 receives the transmitted map, and the map display means 50 displays the map on the display unit 30. The operations of the remaining portions, such as the advertisement-cost calculation unit 10, are the same as those in the above-described embodiments.

As described above, the present invention enables the cost of each advertisement to increase in a certain location and region or a certain time slot and season which is popular among users or occupies the interest of users, or in which a larger number of requests for advertisement postings are made by advertisers. This conforms with the market principle that even when the cost of an advertisement is comparatively high, the advertisement has a value higher than the advertisement cost, if the advertisement is used by many users. Therefore, it becomes possible to set the cost of each advertisement such that both a requester who requests posting of the advertisement; i.e., an advertiser, and a provider who provides an advertisement medium are satisfied.

What is claimed is:

1. An advertisement posting system comprising:
an advertisement-cost calculation unit calculating the cost of an advertisement in consideration of a geographical factor; and
an advertisement posting unit posting the advertisement on an information terminal in a manner related to the geographical factor.

2. An advertisement posting system comprising:
an advertisement-cost calculation unit calculating the cost of an advertisement in consideration of a geographical factor and a status of use of the advertisement related to the geographical factor;
an advertisement posting unit posting the advertisement on an information terminal in a manner related to the geographical factor; and
a status-of-use acquisition unit acquiring the status of use of the advertisement related to the geographical factor.

3. An advertisement posting system comprising:
an advertisement-cost calculation unit calculating the cost of an advertisement in consideration of a geographical factor and user information of the advertisement;
an advertisement posting unit posting the advertisement on an information terminal in a manner related to the geographical factor; and
a unit designating or acquiring the user information of the presented advertisement.

4. An advertisement posting system comprising:
an advertisement-cost calculation unit calculating the cost of an advertisement in consideration of a temporal factor; and
an advertisement posting unit posting the advertisement on an information terminal in a manner related to the temporal factor.

5. An advertisement posting system comprising:
an advertisement-cost calculation unit calculating the cost of an advertisement in consideration of a temporal factor and a status of use of the advertisement related to the temporal factor;
an advertisement posting unit posting the advertisement on an information terminal in a manner related to the temporal factor; and
a status-of-use acquisition unit acquiring the status of use of the advertisement related to the temporal factor.

6. An advertisement posting system comprising:
an advertisement-cost calculation unit calculating the cost of an advertisement in consideration of a temporal factor and user information of the advertisement;
an advertisement posting unit posting the advertisement on an information terminal in a manner related to the temporal factor; and
a unit designating or acquiring the user information of the presented advertisement.

7. A method of calculating an advertisement cost in a system for posting an advertisement on an information terminal in a manner related to either or both of a geographical factor or temporal factor comprising:
at the time of cost estimation for the advertisement or agreement for the advertisement, inputting information regarding either the geographical factor such as location or region in which the advertisement is to be posted, or the temporal factor such as time slot, type of day, or season in which the advertisement is to be posted, or both of the geographical factor and the temporal;
referring to a base cost calculation table on the basis of the input data, the base cost calculation table storing a base cost of the advertisement which is set in advance to be related to either the geographical factor or the temporal factor or both of the geographical factor and the temporal factor; and
calculating the cost of the advertisement on the basis of data obtained through reference of the base cost calculation table and in accordance with either or both of the geographical factor and the temporal factor.

8. A computer readable record medium which stores a program for calculating an advertisement cost in a system for posting an advertisement on an information terminal in a manner related to either or both of a geographical factor and the temporal, the program causing a computer to execute:
at the time of cost estimation for the advertisement or agreement for the advertisement, processing for inputting information regarding either the geographical factor such as location or region in which the advertisement is to be posted, or the temporal factor such as time slot, type of day, or season in which the advertisement is to be posted, or both of the geographical factor and the temporal factor;
processing for referring to a base cost calculation table on the basis of the input data, the base cost calculation table storing a base cost of the advertisement which is set in advance to be related to either the geographical factor or the temporal factor or a combination of the geographical factor and the temporal factor; and
processing for calculating the cost of the advertisement on the basis of data obtained through reference of the base cost calculation table and in accordance with either or both of the geographical factor and the temporal factor.

9. An advertisement posting system comprising:
an advertisement-cost calculation means for calculating the cost of an advertisement in consideration of a geographical factor; and
an advertisement posting means for posting the advertisement on an information terminal in a manner related to the geographical factor.

10. An advertisement posting system comprising:
an advertisement-cost calculation means for calculating the cost of an advertisement in consideration of a geographical factor and a status of use of the advertisement related to the geographical factor;
an advertisement posting means for posting the advertisement on an information terminal in a manner related to the geographical factor; and
a status-of-use acquisition means for acquiring the status of use of the advertisement related to the geographical factor.

11. An advertisement posting system comprising:
an advertisement-cost calculation means for calculating the cost of an advertisement in consideration of a geographical factor and user information of the advertisement;
an advertisement posting means for posting the advertisement on an information terminal in a manner related to the geographical factor; and
a means for designating or acquiring the user information of the presented advertisement.

12. An advertisement posting system comprising:
an advertisement-cost calculation means for calculating the cost of an advertisement in consideration of a temporal factor; and
an advertisement posting means for posting the advertisement on an information terminal in a manner related to the temporal factor.

13. An advertisement posting system comprising:
an advertisement-cost calculation means for calculating the cost of an advertisement in consideration of a temporal factor and a status of use of the advertisement related to the temporal factor;
an advertisement posting means for posting the advertisement on an information terminal in a manner related to the temporal factor; and
a status-of-use acquisition means for acquiring the status of use of the advertisement related to the temporal factor.

14. An advertisement posting system comprising:
an advertisement-cost calculation means for calculating the cost of an advertisement in consideration of a temporal factor and user information of the advertisement;
an advertisement posting means for posting the advertisement on an information terminal in a manner related to the temporal factor; and
a means for designating the user or acquiring information of the present.
